(19) United States
(12) Patent Application Publication
(10) Pub. No.: US 2026/0319698 A1
(43) Pub. Date: Oct. 15, 2026

(54) SHINGLED MAGNETIC RECORDING DATA STORAGE DEVICE WITH OPTIMIZED WRITE PERFORMANCE FOR AN UNEQUAL NUMBER OF READERS AND WRITERS

(71) Applicant: WESTERN DIGITAL TECHNOLOGIES, INC., San Jose, CA (US)

(72) Inventors: Ali Khalili, Minneapolis, MN (US); David R. Hall, Rochester, MN (US); Andrew Larson, Rochester, MN (US); Shad H. Thorstenson, Rochester, MN (US)

(21) Appl. No.: 19/179,372

(22) Filed: Apr. 15, 2025

(51) Int. Cl. G06F 3/06; G11B 20/12

(52) U.S. Cl. CPC G06F 3/0656; G06F 3/0604; G06F 3/0659; G06F 3/0676; G11B 20/1217; G11B 2020/1238

(57) ABSTRACT

Various illustrative aspects are directed to a data storage device, method, and one or more processing devices that are configured to: divide respective data associated with respective write commands into first portions and second portions; write the first portions to a first track in a shingled magnetic recording (SMR) zone; store the second portions in a buffer; and responsive to an amount of data stored in the buffer reaching or exceeding a limit, write the second portions to one or more additional tracks in the SMR zone.

### BACKGROUND

Data storage devices such as disk drives comprise a disk and a head connected to a distal end of an actuator arm, which is rotated about a pivot by a voice coil motor (VCM) to position the head radially over the disk. The disk comprises a plurality of radially spaced, concentric tracks for recording user data sectors and servo wedges or servo sectors. The servo sectors comprise head positioning information (e.g., a track address), which is read by the head and processed by a servo control system to control the actuator arm as it seeks from track to track.

FIG. 1 shows a prior art disk format 2 as comprising a number of radially-spaced, concentric servo tracks 4 defined by servo wedges 6₀-6_{N} recorded around the circumference of each servo track. A plurality of concentric data tracks is defined relative to the servo tracks 4, wherein the data tracks may have the same or a different radial density (e.g., tracks per inch (TPI)) than the servo tracks 4. Each servo wedge 6ᵢ comprises a preamble 8 for storing a periodic pattern, which enables proper gain adjustment and timing synchronization of the read signal, and a sync mark 10 for storing a special pattern used to symbol synchronize to a servo data field 12. The servo data field 12 stores coarse head positioning information, such as a servo track address, used to position the head over a target data track during a seek operation. Each servo wedge (e.g., servo wedge 6₄) further comprises groups of phase-based servo bursts 14 (e.g., N and Q servo bursts), which are recorded with a predetermined phase relative to one another and relative to the servo track centerlines.

The coarse head position information is processed to position a head over a target data track during a seek operation, and the servo bursts 14 provide fine head position information used for centerline tracking while accessing a data track during write/read operations. A position error signal (PES) is generated by reading the servo bursts 14, wherein the PES represents a measured position of the head relative to a centerline of a target servo track. A servo controller processes the PES to generate a control signal applied to one or more head actuators in order to actuate the head radially over the disk in a direction that reduces the PES. The one or more head actuators may comprise a voice coil motor, as well as one or more fine control actuators such as milliactuators or microactuators, in some examples.

Shingled magnetic recording (SMR) is a magnetic storage data recording technology used in hard disk drives to increase storage density compared to conventional magnetic recording (CMR) disk drives. SMR disk drives achieve this by writing data sequentially and then overlapping (or “shingling”) it with another track of data. The write element used in SMR disk drives is typically wider than a single track defined on the disk surface. After one track has been written, the write element is advanced only part of its width so that the data written in the next track will partially overwrite the data in the previous track, leaving only a narrow band of data in the previous track for reading. In an SMR disk drive, overlapping tracks are grouped into bands called SMR zones. In contrast to traditional CMR disk drives, direct modification of already-written data is not permitted in an SMR disk drive. Instead, because of the shingled format of SMR, should a particular track need to be modified or re-written, the entire SMR zone must be rewritten.

Multi-access disk drives are configured to read data from multiple tracks of one or more disk surfaces simultaneously using multiple read elements to achieve an increased read data rate compared to disk drives that read data from only a single track at a time using a single read element. Some multi-access disk drives include an unequal number of readers and writers in a head (or slider), such as one writer and two readers in the same head.

### SUMMARY

Various examples disclosed herein provide data storage devices comprising multi-access disk drives that utilize SMR technology (referred to herein as multi-access SMR disk drives) that have an unequal number of readers and writers in a head and control circuitry configured to perform novel and inventive methods for writing data to multiple tracks on a disk surface. In one example, control circuitry of this disclosure is inventively configured to write first portions of data associated with multiple write commands to a first track in an SMR zone while accumulating second portions of the data associated with the multiple write commands in a buffer, and to write the second portions of the data to one or more additional tracks in the SMR zone responsive to an amount of data in the buffer reaching or exceeding a limit. In another example, control circuitry of this disclosure is inventively configured to write data associated with one or more write commands sequentially to a first track in an SMR zone and one or more additional tracks in the SMR zone. In both examples, the control circuitry may perform the writing to the first track and the one or more additional tracks utilizing a formatting in which sequential logical block addresses (LBAs) are mapped to physical locations in ones of the first track and the one or more additional tracks in an alternating manner. In both examples, the control circuitry may be further configured to read data from the first track and the one or more additional tracks by passing multiple read elements simultaneously over the first track and the one or more additional tracks.

Various illustrative aspects are directed to a data storage device comprising a disk having a disk surface that includes a plurality of tracks in a shingled magnetic recording (SMR) zone, a head configured to be positioned proximate to the disk surface and including N number of read elements and M number of write elements, wherein N is greater than M, and one or more processing devices, individually or in combination, configured to: divide respective data associated with respective write commands into first portions and second portions; write the first portions to a first track in the SMR zone; store the second portions in a buffer; and in response to an amount of data stored in the buffer reaching a limit, write the second portions to one or more additional tracks in the SMR zone.

Various illustrative aspects are directed to a method comprising: dividing, by one or more processing devices individually or in combination, respective data associated with respective write commands into first portions and second portions; writing, by the one or more processing devices individually or in combination, the first portions to a first track in a shingled magnetic recording (SMR) zone defined on a disk surface of a disk in a disk drive; storing, by the one or more processing devices individually or in combination, the second portions in a buffer; and, in response to an amount of data stored in the buffer reaching a limit, writing, by the one or more processing devices individually or in combination, the second portions to one or more additional tracks in the SMR zone.

Various illustrative aspects are directed to one or more processing devices comprising: means for writing data associated with one or more write commands to paired tracks in a shingled magnetic recording (SMR) zone using M number of write elements in a head; and means for reading the data using N number of read elements in the head by passing the N number of read elements simultaneously over the paired tracks.

Various further aspects are depicted in the accompanying figures and described below and will be further apparent based thereon.

### BRIEF DESCRIPTION OF THE DRAWINGS

Various features and advantages of the technology of the present disclosure will be apparent from the following description of particular examples of those technologies and as illustrated in the accompanying drawings. The drawings are not necessarily to scale. The emphasis instead is placed on illustrating the principles of the technological concepts. In the drawings, like reference characters may refer to the same parts throughout the different views. The drawings depict only illustrative examples of the present disclosure and are not limiting in scope.

FIG. 1 shows a prior art disk format comprising a number of radially-spaced, concentric servo tracks defined by servo wedges recorded around the circumference of each servo track.

FIGS. 2A and 2B illustrate conceptual block diagrams of a top view and a side view of a data storage device in the form of a disk drive, in accordance with aspects of the present disclosure.

FIG. 2C depicts a flowchart for an example method that control circuitry of a disk drive may perform or execute in controlling the operations of the disk drive, in accordance with aspects of the present disclosure.

FIG. 3 illustrates a conceptual block diagram of a top view of a head relative to a disk in a multi-access disk drive in accordance with various aspects of the present disclosure.

FIG. 4 illustrates a conceptual block diagram of a mapping of portions of tracks on a disk surface to logical block addresses (LBAs) in accordance with various aspects of the present disclosure.

FIGS. 5-10 show conceptual block diagrams depicting an exemplary use case of receiving multiple write commands, dividing data associated with the write commands into first portions and second portions, writing the first portions to a first track in an SMR zone, storing the second portions in a buffer, and writing the second portions to one or more additional tracks in the SMR zone in accordance with various aspects of the present disclosure

FIG. 11 illustrates a conceptual block diagram illustrating writing data associated with one or more write commands sequentially to a first track in an SMR zone and one or more additional tracks in the SMR zone in accordance with various aspects of the present disclosure.

FIG. 12 illustrates a conceptual block diagram illustrating writing data associated with one write command sequentially to a first track in an SMR zone and one or more additional tracks in the SMR zone in accordance with various aspects of the present disclosure.

### DETAILED DESCRIPTION

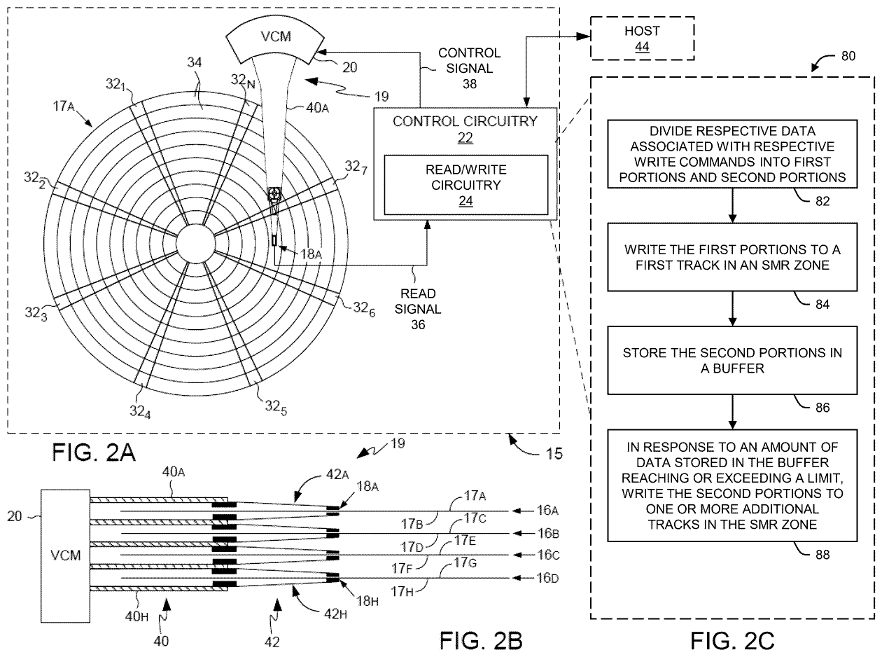

FIGS. 2A and 2B illustrate conceptual block diagrams of a top view and a side view of a data storage device in the form of a disk drive 15, in accordance with aspects of the present disclosure. Disk drive 15 comprises control circuitry 22, an actuator arm assembly 19, and a plurality of hard disks 16A, 16B, 16C, 16D (“hard disks 16”). FIG. 2C depicts a flowchart for an example method 80 that read/write circuitry 24 of control circuitry 22 may perform or execute in controlling the operations of disk drive 15, including optimizing write performance in multi-access SMR disk drives having an unequal number of readers and writers in accordance with aspects of the present disclosure.

Actuator arm assembly 19 comprises a primary actuator 20 (e.g., a voice coil motor (VCM)) and a number of actuator arms 40 (e.g., topmost actuator arm 40A, as seen in the top and side views of FIGS. 2A and 2B). Each of actuator arms 40 comprises a suspension assembly 42 at a distal end thereof (e.g., topmost suspension assembly 42A comprised in topmost actuator arm 40A, in the view of FIGS. 2A and 2B). Each suspension assembly 42 may comprise one or more additional fine actuators, in some examples.

Each of actuator arms 40 is configured to suspend a read/write head 18 in close proximity over a corresponding disk surface 17 (e.g., read/write head 18A suspended by topmost actuator arm 40A over topmost corresponding disk surface 17A and read/write head 18H suspended by lowest actuator arm 40H over lowest corresponding disk surface 17H). Other examples may include any of a wide variety of other numbers of hard disks and disk surfaces, and other numbers of actuator arm assemblies, primary actuators, and fine actuators besides the one actuator arm assembly 19 and the one actuator in the form of primary actuator 20 in the example of FIGS. 2A and 2B, for example.

In various examples, disk drive 15 may be considered to perform or execute functions, tasks, processes, methods, and/or techniques, including aspects of example method 80, in terms of its control circuitry 22 performing or executing such functions, tasks, processes, methods, and/or techniques. Control circuitry 22 may comprise and/or take the form of one or more driver devices and/or one or more other processing devices of any type, and may implement or perform functions, tasks, processes, methods, or techniques by executing computer-readable instructions of software code or firmware code, on hardware structure configured for executing such software code or firmware code, in various examples. Control circuitry 22 may also implement or perform functions, tasks, processes, methods, or techniques by its hardware circuitry implementing or performing such functions, tasks, processes, methods, or techniques by the hardware structure in itself, without any operation of software, in various examples. Control circuitry 22 may be operatively in communicative and/or control connection or coupling with a host 44, which may include any external processing, computing, and/or data management entity, such as a computing device, a storage area network, a data center, a cloud computing resource of any kind, and/or any other kind of host, in various examples.

Control circuitry 22 may comprise one or more processing devices that constitute device drivers, specially configured for driving and operating certain devices, and one or more modules. Such device drivers may comprise one or more head drivers, configured for driving and operating heads 18. Device drivers may be configured as one or more integrated components of one or more larger-scale circuits, such as one or more power large-scale integrated circuit (PLSI) chips or circuits, and/or as part of control circuitry 22, in various examples. Device drivers may also be configured as one or more components in other large-scale integrated circuits such as system on chip (SoC) circuits, or as more or less stand-alone circuits, which may be operably coupled to other components of control circuitry 22, in various examples.

Primary actuator 20 may perform primary, macroscopic actuation of a plurality of actuator arms 40, each of which may suspend one of heads 18 over and proximate to corresponding disk surfaces 17 of disks 16. The positions of heads 18, e.g., heads 18A and 18H, are indicated in FIG. 2A, although heads 18 are generally positioned very close to the disk surfaces and are too small to be visible if depicted to scale in FIGS. 2A and 2B.

Example disk drive 15 of FIGS. 2A and 2B comprises four hard disks 16. Other examples may comprise any number of disks, such as just one disk, two disks, three disks, or five or more disks, or ten or eleven or more disks. Hard disks 16 may also be known as platters, and their disk surfaces may also be referred to as media, or media surfaces. The four hard disks 16 comprise eight disk surfaces 17A, 17B, 17C, 17D, 17E, 17F, 17G, and 17H (“disk surfaces 17”), with one disk surface 17 on each side of each hard disk 16, in this illustrative example. Actuator assembly 19 suspends heads 18 of each actuator arm 40 over and proximate to a corresponding disk surface 17, enabling each of heads 18 to write control features and data to, and read control features and data from, its respective, proximate disk surface 17. In this sense, each head 18 of each actuator arm 40 interacts with a corresponding disk surface 17. As used herein, a head 18 may be said to operate “over” a corresponding disk surface 17 in terms that define the local frame of reference in accordance therewith.

The term “disk surface” may be understood to have the ordinary meaning it has to persons skilled in the applicable engineering fields of art. The term “disk surface” may be understood to comprise both the very outer surface layer of a disk as well as a volume of disk matter beneath the outer surface layer, which may be considered in terms of atomic depth, or (in a simplified model) the number of atoms deep from the surface layer of atoms in which the matter is susceptible of physically interacting with the heads. The term “disk surface” may comprise the portion of matter of the disk that is susceptible of interacting with a read/write head in disk drive operations, such as control write operations, control read operations, data write operations, and data read operations, for example.

In the embodiment of FIGS. 2A and 2B, each disk surface, e.g., disk surface 17A as shown in FIG. 2A, comprises a plurality of control features. The control features comprise servo wedges 32₁-32_{N}, which define a plurality of servo tracks 34, wherein data tracks are defined relative to the servo tracks 34, and which may be at the same or different radial density. Control circuitry 22 processes a read signal 36 emanating from the respective head, e.g., head 18A, to read from disk surface 17A, to demodulate the servo wedges 32₁-32_{N} and generate a position error signal (PES) representing an error between the actual position of the head and a target position relative to a target track. A servo control system in the control circuitry 22 filters the PES from the servo wedges using a suitable compensation filter to generate a control signal 38 applied to actuator arm assembly 19, including to control actuator 20, which functions as a primary actuator, and which rotates actuator arm assembly 19 about an axial pivot in order to perform primary actuation of the corresponding heads 18 radially over the disk surfaces 17 in a direction that reduces the PES, as well as to control any fine actuators, in various examples. Control circuitry 22 may also apply control signals to and receive sensor signals from heads 18 and/or any of various components of disk drive 15, in various examples.

In the example of FIGS. 2A and 2B, actuator arm assembly 19 rotates actuator arms 40 about a common pivot. In another example, a first actuator arm assembly and/or VCM and a second actuator arm assembly and/or VCM, or other types of primary actuators, may each be configured to actuate respective actuator arm assemblies or sets of multi-actuator arms about separate pivots, for example, mounted at different circumferential locations about the disks. In some examples, each of the two actuator arm assemblies may control half of the heads and write to and read from half of the disk surfaces. In some examples, each of the actuator arm assemblies may be addressable by host 44 as a separate logical data storage unit. Other examples may employ more than two actuator arm assemblies or primary actuators or multi-actuators, which may be actuated about a common pivot, or which may be comprised in multiple multi-actuators mounted at different circumferential locations about the disks. Actuator arm assembly 19 and/or any of these other examples may thus constitute and/or comprise an actuator mechanism, in various examples. An actuator mechanism such as actuator arm assembly 19 may thus be configured to position heads 18, including a selected head among one or more heads 18, proximate to a corresponding disk surface 17 among the one or more disks 16.

In executing example method 80 of FIG. 2C (aspects of which will also be further explained below with reference to the further figures), control circuitry 22 may issue one or more commands to other components of disk drive 15, receive information from one or more other components of disk drive 15, and/or perform one or more internal operations, such as generating one or more driver currents for outputting to system components of disk drive 15. In a particular example, read/write circuitry 24 of control circuitry 22 may divide respective data associated with respective write commands into first portions and second portions (82). Read/write circuitry 24 may further write the first portions to a first track in an SMR zone (84). Read/write circuitry 24 may further store the second portions in a buffer (86). Read/write circuitry 24 may further, in response to an amount of data stored in the buffer reaching a limit, write the second portions to one or more additional tracks in the SMR zone (88). Control circuitry 22, including read/write circuitry 24, may further perform additional actions, methods, and techniques, in accordance with various aspects including as further described herein.

The term “read/write circuitry 24” as used herein may refer to any hardware, firmware, software, and/or combination thereof, comprised in control circuitry 22 of disk drive 15, which implements, embodies, or engages in any of the structures or functions ascribed herein to read/write circuitry 24 or to any other of the novel and inventive aspects of the present disclosure. Read/write circuitry 24 may constitute any hardware, firmware, software, and/or any other elements of control circuitry 22 for optimizing write performance in multi-access SMR disk drives having an unequal number of readers and writers and performing other techniques and methods as described herein.

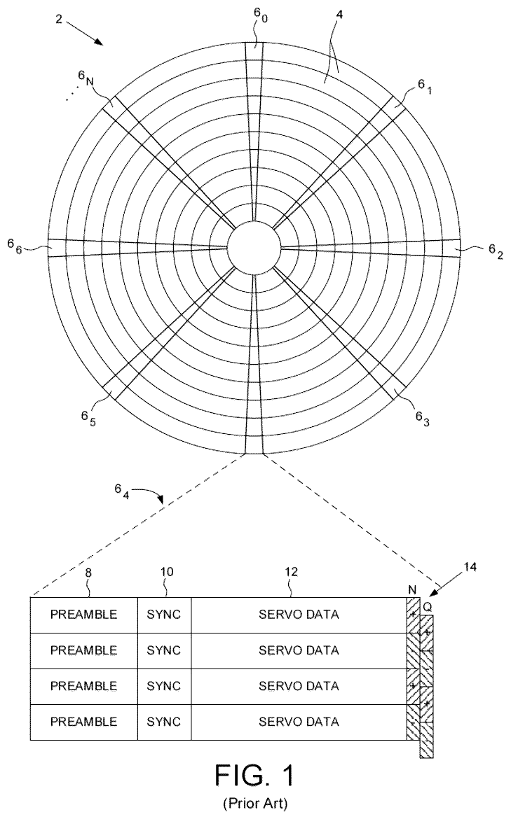

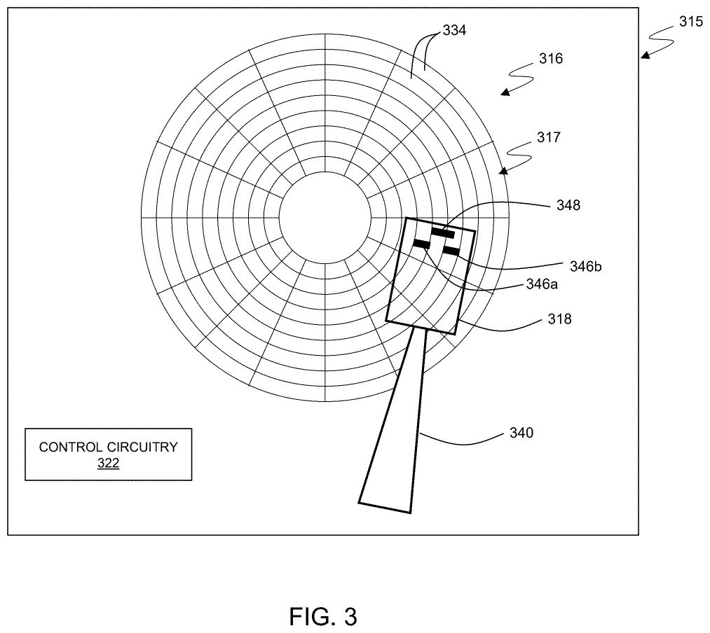

FIG. 3 illustrates a conceptual block diagram of a top view of a head relative to a disk in accordance with various aspects of the present disclosure. In particular, FIG. 3 shows a disk drive 315 including a disk 316 that corresponds to one of disks 16 of FIG. 2B, a head 318 that corresponds to one of heads 18 of FIG. 2B, and control circuitry 322 that corresponds to control circuitry 22 of FIG. 2A. Disk drive 315 may correspond to disk drive 15 of FIG. 2A and may be configured to perform the method of FIG. 2C in accordance with aspects of the present disclosure. Disk surface 317 includes a plurality of concentric tracks 334 each divided into plural data sectors for recording user data. Although not shown, each of the tracks 334 may also include plural servo sectors that contain servo information such as that described with respect to servo wedges 6ᵢ of FIG. 1.

In embodiments, disk drive 315 comprises a multi-access SMR disk drive. Disk surface 317 may include one or more SMR zones each comprising a group of adjacent ones of tracks 334. Control circuitry 322 may maintain respective write pointers associated with respective ones of the SMR zones, where the respective write pointer for a respective SMR zone indicates the next location (e.g., logical block address) in the respective SMR zone at which data will be written in the sequential manner used by SMR disk drives (e.g., by writing data and then overlapping (or shingling) it with another track of data).

In various embodiments, head 318 includes M number of write elements 348 (also called writers), each of which may comprise an inductive write coil, and N number of read elements 346a and 346b (also called readers), each of which may comprise a magnetoresistive (MR) element. Control circuitry 322 may write data to disk surface 317 by modulating a write current in an inductive write coil in write element 348 to record magnetic transitions onto corresponding disk surface 317 in a process referred to as saturation recording. During readback, read elements 346a and 346b sense the magnetic transitions and a read channel demodulates the resulting read signal. Write element 348 may be wider than individual ones of tracks 334 so that once data has been written to one of the tracks 334 and head 318 advances write element 348 to a next adjacent track, data written to the next adjacent track partially overlaps the data written to the previous track, leaving only a narrow band of data in the previous track for reading. In the example shown in FIG. 3, head 318 is supported over disk surface 317 by actuator arm 340 that may be rotated about a pivot by an actuator (e.g., a VCM) to selectively position head 318 radially over disk 316. Although not shown, head 318 may include other elements, such as a fly height actuator, for example.

In various embodiments, the number of read elements in head 318 is greater than the number of write elements (e.g., N>M). In the example shown in FIG. 3, head 318 includes two read elements 346a and 346b (N=2) and one write element 348 (M=1). In response to a read command received from a host (e.g., host 44 of FIG. 2A), disk drive 315 may read data concurrently from two paired tracks on disk surface 317 by passing the two read elements 346a and 346b simultaneously over the paired tracks, thereby enabling substantially double the read throughput compared to disk drives that read data from only a single track at a time using a single read element. Embodiments are not limited to the example shown in FIG. 3 where N=2 and M=1, and implementations may include other values for M (i.e., number of write elements) and other values for N (i.e., number of read elements) where N is greater than M and where the write element(s) and read elements are in a same head and interact with a same corresponding disk surface.

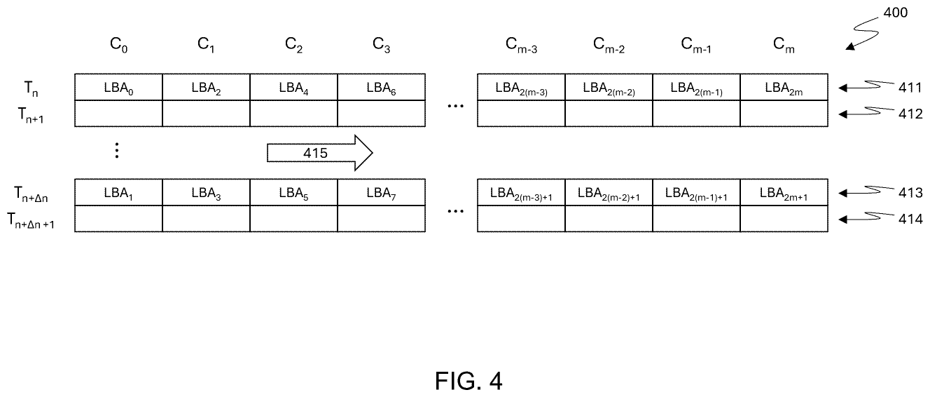

FIG. 4 illustrates a conceptual block diagram of a mapping of portions of tracks on a disk surface to logical block addresses (LBAs) in accordance with various aspects of the present disclosure. In particular, FIG. 4 shows a portion of a logical-physical map 400 in which sequential ones of a plurality of LBAs (e.g., LBA₀, LBA₁, LBA₂, LBA₃, etc.) are mapped to respective containers defined in a first track 411 and a second track 413 in an alternating manner between the first track 411 and the second track 413 along a down-track direction 415 associated with the first track 411 and the second track 413. Data defining map 400 may be stored in control circuitry 322 and used by control circuitry 322 when writing data to, and reading data from, disk 316. In the example shown in FIG. 4, tracks 411, 412, 413, and 414 correspond to respective ones of tracks 334 on disk surface 317 of disk 316 of FIG. 3. Additional tracks may be present on the disk surface 317, although they are not shown in FIG. 4. In this example, track 411 represents track number Tₙ, track 412 represents track number Tₙ₊₁, track 413 represents track number T_{n+Δn}, and track 414 represents track number T_{n+Δn+1}. In this example, tracks 411 and 413 represent a first set of paired tracks that are configured to be read simultaneously using the two read elements 346a and 346b of FIG. 3, and tracks 412 and 414 represent a second set of paired tracks that are configured to be read simultaneously using the two read elements 346a and 346b of FIG. 3. Additional sets of paired tracks that are configured to be read simultaneously may be defined on the disk surface, although they are not shown in FIG. 4.

In the example shown in FIG. 4, tracks 411, 412, 413, and 414 are all included in a same SMR zone defined on disk surface 317 of disk 316 of FIG. 3. As such, control circuitry 322 may be configured to write data in adjacent ones of the tracks in an overlapping manner, e.g., by shingling the data written to one track over the data previously written to an adjacent track. For example, control circuitry 322 may be configured to write data to track 411 and then subsequently write data to track 412, where the data written in track 412 overlaps the data written in track 411. Additional tracks may be included on the SMR zone, although they are not shown in FIG. 4.

With continued reference to FIG. 4, and in accordance with aspects of the present disclosure, a plurality of logical space containers is defined in each of the tracks 411-414. In the example shown in FIG. 4, each of the tracks 411-414 is divided into logical space containers C₀, C₁, C₂, C₃, . . . , Cₘ₋₃, Cₘ₋₂, Cₘ₋₁, Cₘ (referred to herein as containers). Embodiments are not limited to “m” number of containers in the tracks, and more or fewer than this number of containers may be defined in the tracks in other implementations. In embodiments, each of the containers C₀-Cₘ has a same size that may correspond to the size of one or more data sectors defined by the formatting of the disk drive. In a particular non-limiting example, each of the containers C₀-Cₘ is sized to store 64 KB (kilobytes) of data.

In accordance with aspects of the present disclosure, map 400 is configured such that sequential LBAs in respective groups of LBAs are mapped to respective ones of the containers C₀-Cₘ in a set of paired tracks in an alternating manner between the paired tracks along a down-track direction associated with the paired tracks. For example, as shown in FIG. 4, a first group of sequential LBAs includes LBA₀, LBA₁, LBA₂, LBA₃, . . . , LBA₂₍ₘ₋₁₎, LBA₂₍ₘ₋₁₎₊₁, LBA₂ₘ, LBA₂ₘ₊₁ that are mapped to respective ones of the containers C₀-Cₘ in paired tracks 411 and 413 in an alternating manner between the paired tracks 411 and 413 along the down track direction 415. In this particular example, LBA₀ is mapped to container C₀ in track 411, LBA₁ is mapped to container C₀ in track 413, LBA₂ is mapped to container C₁ in track 411, LBA₃ is mapped to container C₁ in track 413, and so on. In this manner, map 400 alternates the sequential LBAs between the paired tracks 411 and 413 in the down-track direction 415. Embodiments are not limited to this number of sequential LBAs in a group of LBAs, and more or fewer than this number of sequential LBAs may be used in respective groups. Moreover, although the mapping is illustrated for only tracks 411 and 413, it is understood that a similar logic may be used for mapping other LBAs to other containers in other sets of paired tracks on the disk surface.

According to aspects of the present disclosure, control circuitry 322 is configured to receive multiple write commands (e.g., successively from one or more hosts such as host 44) and divide the respective data associated with the respective write commands into first portions and second portions. In embodiments, the first portions comprise one or more respective first data chunks associated with respective ones of the write commands, and the second portions comprise one or more respective second data chunks associated with the respective ones of the write commands. In embodiments, control circuitry 322 writes the first portions to a first one of the paired tracks in the SMR zone and accumulates the second portions in a buffer until the amount of data of the second portions in the buffer reaches or exceeds a limit, at which time control circuitry 322 writes the second portions to a second one of the paired tracks in the SMR zone. In embodiments, in response to subsequently receiving a read command for the respective data associated with a respective one of the write commands, control circuitry 322 is configured to read the requested data by passing the read elements (e.g., 346a and 346b) simultaneously over the paired tracks (e.g., 411 and 413 in this example).

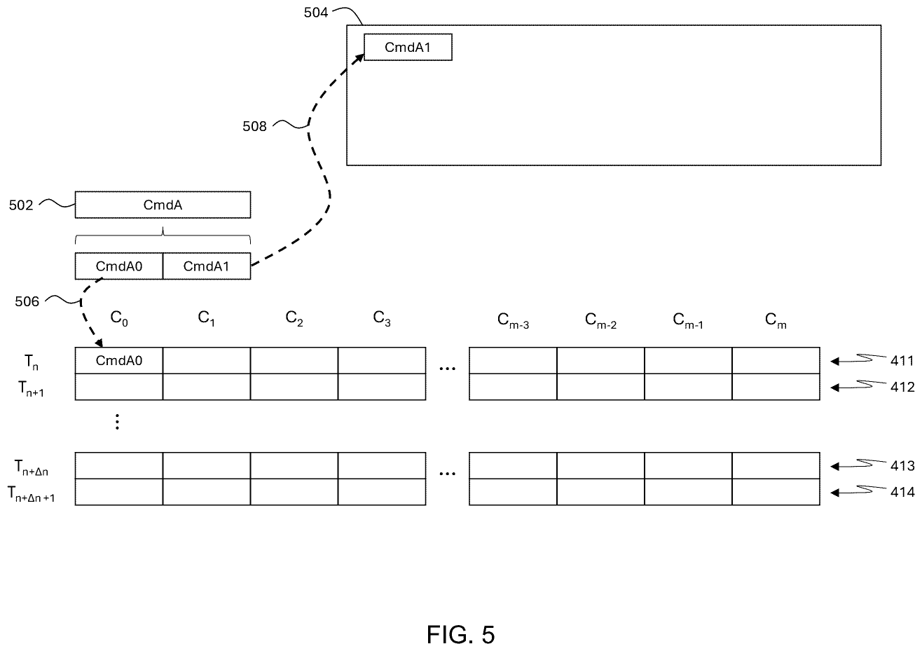

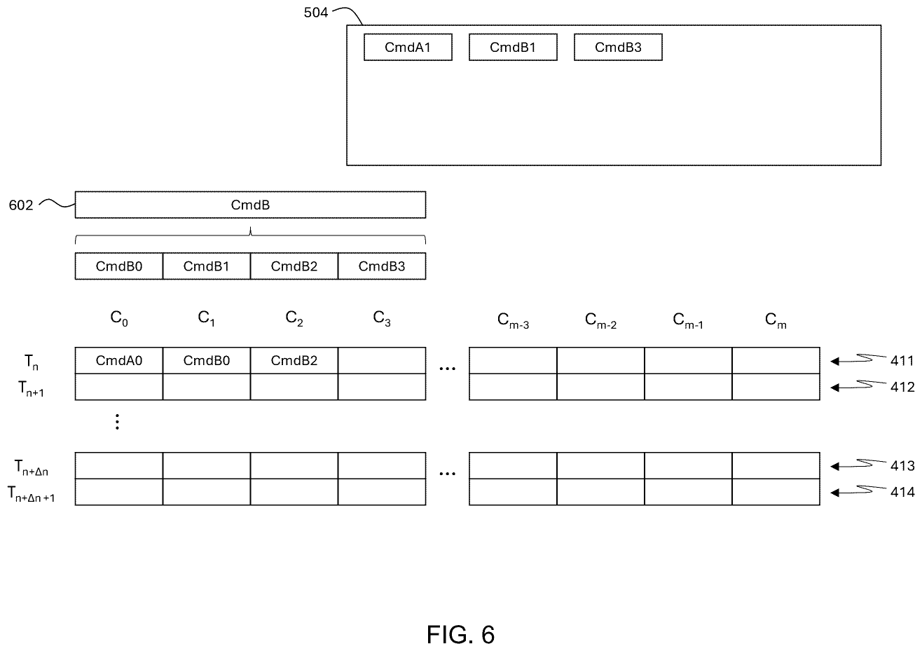

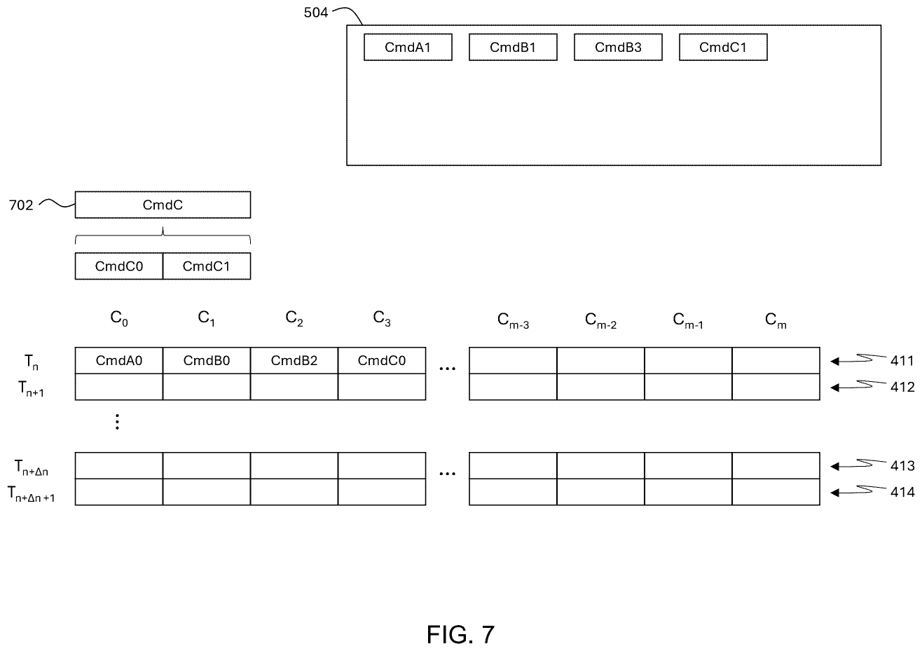

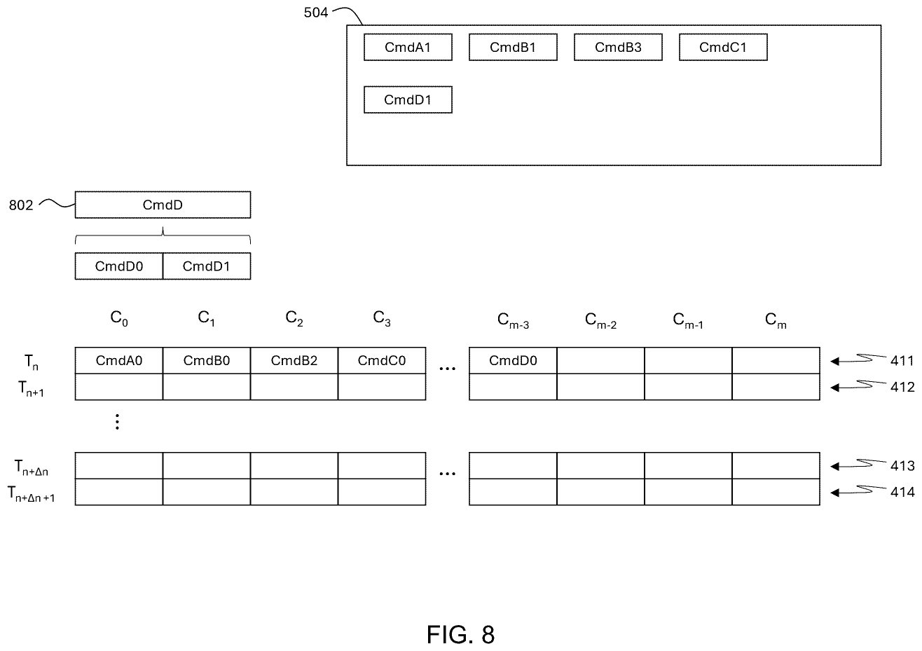

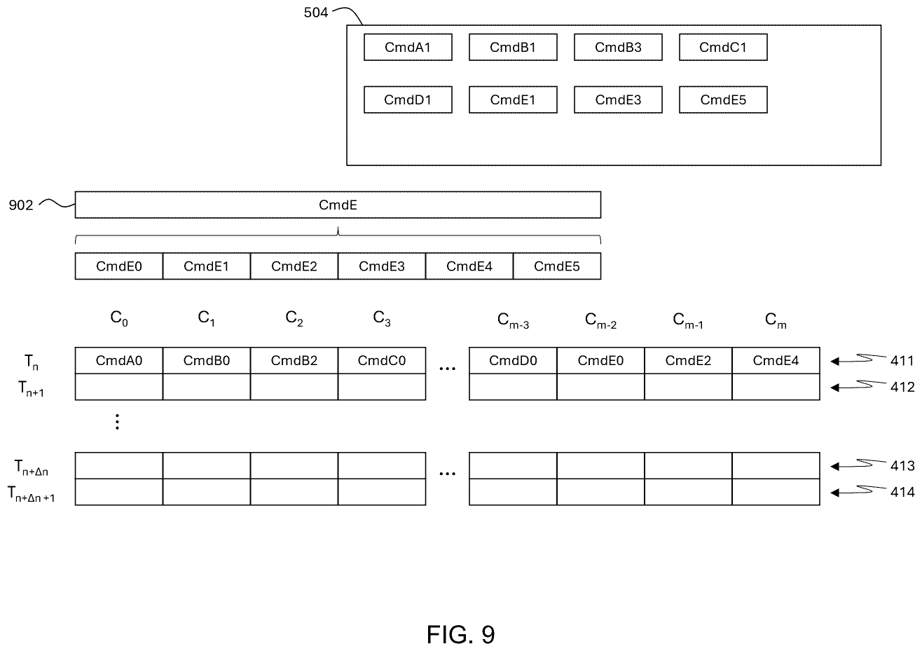

FIGS. 5-10 show conceptual block diagrams depicting an exemplary use case of receiving multiple write commands, dividing data associated with the write commands into first portions and second portions, writing the first portions to a first track in an SMR zone, storing the second portions in a buffer, and writing the second portions to one or more additional tracks in the SMR zone in accordance with various aspects of the present disclosure. Operations associated with FIGS. 5-10 may be performed by control circuitry 322 in disk drive 315 of FIG. 3 using map 400 of FIG. 4, for example.

FIG. 5 shows data 502 associated with a first write command (CmdA) received by disk drive 315 from a host (e.g., host 44). In accordance with aspects of the present disclosure, control circuitry 322 divides data 502 into a respective first data chunk (CmdA0) and a respective second data chunk (CmdA1), wherein the respective data chunks are sized to fit within respective ones of the containers C₀-Cₘ. For example, data 502 may equal 128 KB, and each of the first data chunk (CmdA0) and the second data chunk (CmdA1) may equal 64 KB. In accordance with aspects of the present disclosure, control circuitry 322 writes the respective first data chunk (CmdA0) to container C₀ in track 411 as indicated by arrow 506 and stores the respective second data chunk (CmdA1) in a buffer 504 as indicated by arrow 508. Buffer 504 may comprise any suitable type of memory, such as dynamic random-access memory (DRAM), and may be included in control circuitry 322 or operatively connected to control circuitry 322, e.g., via a bus.

Continuing the exemplary use case shown in FIGS. 5-10, FIG. 6 shows data 602 associated with another write command (CmdB) received by disk drive 315 from a host. In accordance with aspects of the present disclosure, control circuitry 322 divides data 602 into respective first data chunks (CmdB0 and CmdB2) and respective second data chunks (CmdB1 and CmdB3), wherein the respective data chunks are sized to fit within respective ones of the containers C₀-Cₘ. For example, data 602 may equal 256 KB, and each of the first data chunks (CmdB0 and CmdB2) and the second data chunks (CmdB1 and CmdB3) may equal 64 KB. In accordance with aspects of the present disclosure, control circuitry 322 writes the respective first data chunks (CmdB0 and CmdB2) to containers C₁ and C₂ in track 411 and stores the respective second data chunks (CmdB1 and CmdB3) in buffer 504.

Continuing the exemplary use case shown in FIGS. 5-10, FIG. 7 shows data 702 associated with another write command (CmdC) received by disk drive 315 from a host. In accordance with aspects of the present disclosure, control circuitry 322 divides data 702 into a respective first data chunk (CmdC0) and a respective second data chunk (CmdC1), wherein the respective data chunks are sized to fit within respective ones of the containers C₀-Cₘ. For example, data 702 may equal 128 KB, and each of the first data chunk (CmdC0) and the second data chunk (CmdC1) may equal 64 KB. In accordance with aspects of the present disclosure, control circuitry 322 writes the respective first data chunk (CmdC0) to container C₃ in track 411 and stores the respective second data chunk (CmdC1) in buffer 504.

Continuing the exemplary use case shown in FIGS. 5-10, FIG. 8 shows data 802 associated with another write command (CmdD) received by disk drive 315 from a host. In accordance with aspects of the present disclosure, control circuitry 322 divides data 802 into a respective first data chunk (CmdD0) and a respective second data chunk (CmdD1), wherein the respective data chunks are sized to fit within respective ones of the containers C₀-Cₘ. For example, data 802 may equal 128 KB, and each of the first data chunk (CmdD0) and the second data chunk (CmdD1) may equal 64 KB. In accordance with aspects of the present disclosure, control circuitry 322 writes the respective first data chunk (CmdD0) to container Cₘ₋₃ in track 411 and stores the respective second data chunk (CmdD1) in buffer 504.

Continuing the exemplary use case shown in FIGS. 5-10, FIG. 9 shows data 902 associated with another write command (CmdE) received by disk drive 315 from a host. In accordance with aspects of the present disclosure, control circuitry 322 divides data 902 into respective first data chunks (CmdE0, CmdE2, and CmdE4) and respective second data chunks (CmdE1, CmdE3, and CmdE5), wherein the respective data chunks are sized to fit within respective ones of the containers C₀-Cₘ. For example, data 902 may equal 384 KB, and each of the first data chunks (CmdE0, CmdE2, and CmdE4) and the second data chunks (CmdE1, CmdE3, and CmdE5) may equal 64 KB. In accordance with aspects of the present disclosure, control circuitry 322 writes the respective first data chunks (CmdE1, CmdE3, and CmdE5) to containers Cₘ₋₂, Cₘ₋₁, and Cₘ in track 411 and stores the respective second data chunks (CmdE1, CmdE3, and CmdE5) in buffer 504.

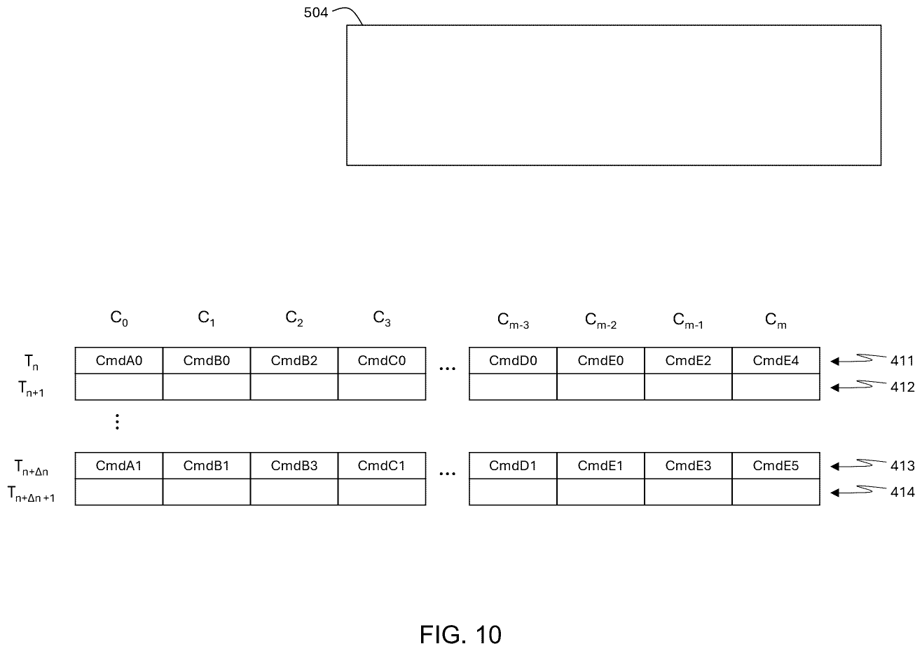

Continuing the exemplary use case shown in FIGS. 5-10, FIG. 10 illustrates control circuitry 322 writing the respective data chunks that have accumulated in buffer 504 to track 413 based on the amount of data stored in buffer 504 reaching a limit. In embodiments, the limit equals the number of read elements minus the number of write elements (i.e., N minus M) times a write capacity of a single track in the SMR zone (e.g., an amount of data that can be written in one track in the SMR zone). In the example shown in FIG. 10, the number of readers is two (N=2), the number of write elements is one (M=1), and the limit equals an amount of data that can be written to one of the tracks (e.g., one of tracks 411-414) in the SMR zone. In embodiments, control circuitry 322 writes the data in buffer 504 to a number of additional tracks equaling N minus M. For example, if N equals three and M equals one, then buffer 504 is sized to store two tracks worth of data chunks while control circuity 322 writes data chunks to the first track, and control circuitry 322 is configured to write the data chunks from buffer 504 to two additional tracks when the amount of data in buffer 504 reaches or exceeds the limit. In embodiments, control circuitry 322 deletes the respective data chunks from buffer 504 based on writing the respective data chunks to the second one of the paired tracks.

With continued reference to FIG. 10, and in accordance with aspects of the present disclosure, in response to a read command to read the data associated with one or more of the write commands (e.g., CmdA, CmdB, CmdC, CmdD, and CmdE in this example), control circuitry 322 is configured to position head 318 relative to disk surface 317 such that the two read elements 346a and 346b pass over the paired tracks (tracks 411 and 413 in this example) simultaneously during a single revolution of the disk 316, such that data from the paired tracks is read concurrently by the two read elements. In this manner, disk drive 315 provides high read data rates associated with multi-access disk drives.

As is evident from FIGS. 5-10, control circuitry 322 may be configured to: divide respective data (e.g., 502, 602, 702, 802, 902) associated with respective write commands (e.g., CmdA, CmdB, CmdC, CmdD, CmdE) into first portions and second portions; write the first portions to a first track (e.g., track 411) in the SMR zone; store the second portions in a buffer (e.g., buffer 504); and, in response to an amount of data stored in the buffer reaching a limit, write the second portions to one or more additional tracks (e.g., track 413) in the SMR zone. In embodiments, the first portions comprise one or more respective first data chunks (e.g., CmdA0, CmdB0, CmdB2, CmdC0, CmdD0, CmdE0, CmdE2, CmdE4) associated with respective ones of the write commands, and the second portions comprise one or more respective second data chunks (e.g., CmdA1, CmdB1, CmdB3, CmdC1, CmdD1, CmdE1, CmdE3, CmdE5) associated with the respective ones of the write commands.

In accordance with further aspects of the present disclosure, control circuitry 322 may be configured to adjust the position of head 318 when writing to a second track of a set of paired tracks based on a detected position of head 318 during writing to a first track of the set of paired tracks. In embodiments, control circuitry 322 may utilize a PES detected at radial locations when writing data to a first one of the paired tracks (e.g., track 411 in the example of FIG. 10) to modify the position of head 318 at corresponding radial locations when writing data to a second one of the paired tracks (e.g., track 413 in the example of FIG. 10). In this manner, an off-center write at a respective radial location in the first track is mimicked at the same radial location in the second track, which maximizes the probability of successfully reading the data in both of the paired tracks when simultaneously passing the multiple read heads over the paired tracks.

As described herein, multi-access SMR disk drives in accordance with aspects of the present disclosure may have N number of read elements and M number of write elements and may use novel and inventive methods for minimizing costs and maximizing benefits of increased throughput. For larger transfer lengths, embodiments enable an N-times increase in the read workload at a same number of IOPS (input/output operations per second) when increasing transfer length by a factor of N compared to disk drives that use a single reader to read data. Expression 1 may be used to determine an amount of throughput increase provided by embodiments.

throughput increase=(r+w)/((r/n)+(w/m)) (Expression 1)

In Expression 1, r represents a proportion of the workload associated with reads, w represents a proportion of the workload associated with writes, n represents a number of read elements, and m represents a number of write elements. In an example using two read elements (n=2), one write element (m=1), fifty percent reads (r=0.5), and fifty percent writes (w=0.5), Expression 1 indicates that embodiments enable a 1.33× increase (33% increase) in overall throughput (e.g., IOPS and mebibytes per second (MiB/s)) compared to disk drives that use a single reader to read data.

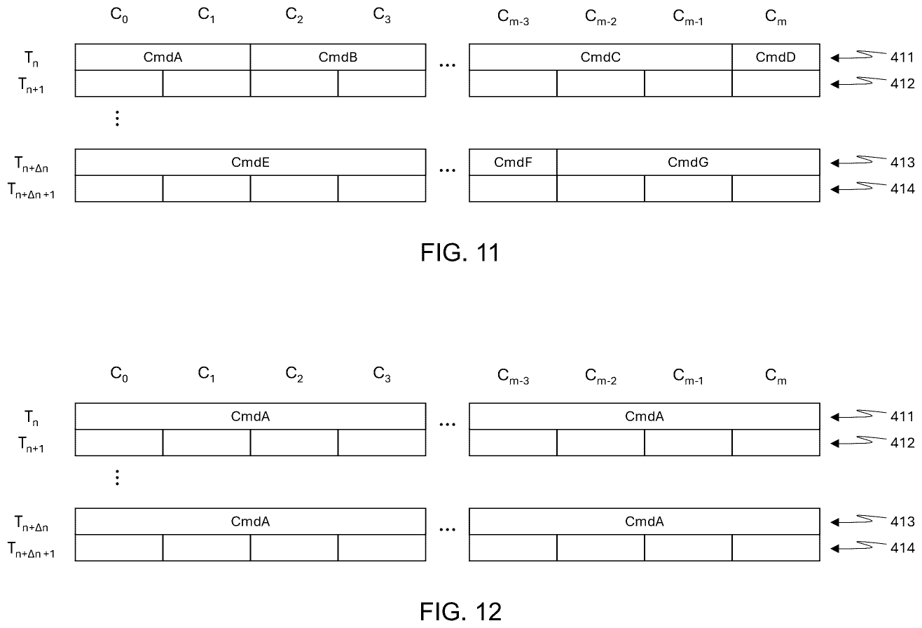

FIG. 11 shows conceptual block diagram illustrating writing data associated with one or more write commands sequentially to a first track in an SMR zone and one or more additional tracks in the SMR zone in accordance with various aspects of the present disclosure. Operations associated with FIG. 11 may be performed by control circuitry 322 in disk drive 315 of FIG. 3 using map 400 of FIG. 4, for example. In embodiments, control circuitry 322 may be configured to write data associated with one or more write commands (CmdA, CmdB, CmdC, CmdD, CmdE, CmdF, and CmdG in the example shown in FIG. 11) sequentially to a first one of paired tracks in an SMR zone (e.g., track 411) and a second one of the paired tracks in the SMR zone (e.g., track 413), without storing data in buffer 504. In this manner, the data associated with the write commands is written to the paired tracks in order. After writing in this manner, control circuitry 322 is configured to read data from the paired tracks by passing multiple read elements simultaneously over the paired tracks, thereby providing the SMR disk drive with high read data rates associated with multi-access disk drives.

FIG. 12 shows conceptual block diagram illustrating writing data associated with one write command sequentially to a first track in an SMR zone and one or more additional tracks in the SMR zone in accordance with various aspects of the present disclosure. Operations associated with FIG. 12 may be performed by control circuitry 322 in disk drive 315 of FIG. 3 using map 400 of FIG. 4, for example. In embodiments, control circuitry 322 may be configured to write data associated with one relatively large write command (CmdA in the example shown in FIG. 12) sequentially to a first one of paired tracks in an SMR zone (e.g., track 411) and a second one of the paired tracks in the SMR zone (e.g., track 413), without storing data in buffer 504. In this manner, the data associated with the write command is written to the paired tracks in order. In one example, a relatively large write command is a write command having an amount of data that is greater than a write capacity of one of the paired tracks (e.g., an amount of data that may be written to a single track). In a particularly advantageous example, a relatively large write command is a write command having an amount of data that is an even integer multiple of the write capacity of one of the paired tracks, such as two or four or six times the amount of data that may be written to a single track. After writing in this manner, control circuitry 322 is configured to read data from the paired tracks by passing multiple read elements simultaneously over the paired tracks, thereby providing the SMR disk drive with high read data rates associated with multi-access disk drives.

Any suitable control circuitry may be employed to implement the flow diagrams in the above examples, such as any suitable integrated circuit or circuits. For example, the control circuitry may be implemented within a read channel integrated circuit, or in a component separate from the read channel, such as a data storage controller, or certain operations described above may be performed by a read channel and others by a data storage controller. In some examples, the read channel and data storage controller may be implemented as separate integrated circuits, and in some examples, the read channel and data storage controller may be fabricated into a single integrated circuit or system on a chip (SoC). In some examples, the control circuitry may include a suitable preamp circuit implemented as a separate integrated circuit, integrated into the read channel or data storage controller circuit, or integrated into an SoC.

In some examples, the control circuitry may comprise a microprocessor executing instructions, the instructions being operable to cause the microprocessor to perform one or more aspects of methods, processes, or techniques shown in the flow diagrams and described with reference thereto herein. Executable instructions of this disclosure may be stored in any computer-readable medium. In some examples, executable instructions of this disclosure may be stored on a non-volatile semiconductor memory device, component, or system external to a microprocessor, or integrated with a microprocessor in an SoC. In some examples, executable instructions of this disclosure may be stored on one or more disks and read into a volatile semiconductor memory when the disk drive is powered on. In some examples, the control circuitry may comprise logic circuitry, such as state machine circuitry. In some examples, at least some of the flow diagram blocks may be implemented using analog circuitry (e.g., analog comparators, timers, etc.). In some examples, at least some of the flow diagram blocks may be implemented using digital circuitry or a combination of analog and digital circuitry.

In various examples, one or more processing devices may comprise or constitute the control circuitry as described herein, and/or may perform one or more of the functions of control circuitry as described herein. In various examples, the control circuitry, or other one or more processing devices performing one or more of the functions of control circuitry as described herein, may be abstracted away from being physically proximate to the disks and disk surfaces. The control circuitry, and/or one or more device drivers thereof, and/or one or more processing devices of any other type performing one or more of the functions of control circuitry as described herein, may be part of or proximate to a rack of multiple data storage devices, or a unitary product comprising multiple data storage devices, or may be part of or proximate to one or more physical or virtual servers, or may be part of or proximate to one or more local area networks or one or more storage area networks, or may be part of or proximate to a data center, or may be hosted in one or more cloud services, in various examples.

In various examples, a disk drive may include a magnetic disk drive, an optical disk drive, a hybrid disk drive, or other types of disk drive. Some examples may include electronic devices such as computing devices, data server devices, media content storage devices, or other devices, components, or systems that may comprise the storage media and/or control circuitry as described above.

The various features and processes described above may be used independently of one another or may be combined in various ways. All possible combinations and subcombinations fall within the scope of this disclosure. Certain method, event, or process blocks may be omitted in some implementations. The methods and processes described herein are not limited to any particular sequence, and the blocks or states relating thereto can be performed in other sequences. For example, described tasks or events may be performed in an order other than that specifically disclosed, or multiple may be combined in a single block or state. The example tasks or events may be performed in serial, in parallel, or in another manner. Tasks or events may be added to or removed from the disclosed examples. The example systems and components described herein may be configured differently than described. For example, elements may be added to, removed from, or rearranged compared to the disclosed examples.

While certain example embodiments are described herein, these embodiments are presented by way of example only and do not limit the scope of the inventions disclosed herein. Thus, nothing in the foregoing description implies that any particular feature, characteristic, step, module, or block is necessary or indispensable. The novel methods and systems described herein may be embodied in a variety of other forms. Various omissions, substitutions, and changes in the form of the methods and systems described herein may be made without departing from the spirit and scope of the present disclosure.

Method 80 and other methods of this disclosure may include other steps or variations in various other embodiments. Some or all of any of method 80 and other methods of this disclosure may be performed by or embodied in hardware, and/or performed or executed by a controller, a central processing unit (CPU), a field-programmable gate array (FPGA), an SoC, a multi-processor system on chip (MPSoC), which may include both a CPU and an FPGA, and other elements together in one integrated SoC, or other processing device or computing device processing executable instructions, in controlling other associated hardware, devices, systems, or products in executing, implementing, or embodying various subject matter of the method. Steps of method 80, and other methods of this disclosure, may be performed individually or in combination by one or more processing devices. For example, in some implementations, the one or more processing devices may comprise a single processing device that performs all the steps of such a method. In some implementations, different respective ones of the one or more processing devices may perform different respective steps of such a method. For example, in some implementations, the one or more processing devices may comprise at least a first processing device that performs a first subset of the steps of such a method and at least a second processing device that performs a second subset of the steps of the method. In some implementations, one or more steps of such a method may be performed by two or more of the one or more processing devices acting in combination.

Data storage systems, devices, and methods implemented with and embodying novel advantages of the present disclosure are thus shown and described herein, in various foundational aspects and in various selected illustrative applications, architectures, techniques, and methods for implementing and embodying novel advantages of the present disclosure. Persons skilled in the relevant fields of art will be well-equipped by this disclosure with an understanding and an informed reduction to practice of a wide panoply of further applications, architectures, techniques, and methods for novel advantages, techniques, methods, processes, devices, and systems encompassed by the present disclosure and by the claims set forth below.

As used herein, the recitation of “at least one of A, B, and C” is intended to mean “either A, B, C, or any combination of A, B, and C.” The descriptions of the disclosed examples are provided to enable any person skilled in the relevant fields of art to understand how to make or use the subject matter of the present disclosure. Various modifications to these embodiments will be readily apparent to those skilled in the art based on the present disclosure, and the generic principles defined herein may be applied to other examples without departing from the spirit or scope of the disclosure. Thus, the present disclosure is not limited to the embodiments shown herein but is to be accorded the widest scope consistent with the principles and novel features disclosed herein.

The present disclosure and many of its attendant advantages will be understood by the foregoing description, and various changes may be made in the form, construction, and arrangement of the components without departing from the disclosed subject matter or without sacrificing all or any of its material advantages. The form described is merely explanatory, and the following claims encompass and include a wide range of embodiments, including a wide range of examples encompassing any such changes in the form, construction, and arrangement of the components as described herein.

While the present disclosure has been described with reference to various examples, it will be understood that these examples are illustrative and that the scope of the disclosure is not limited to them. All subject matter described herein are presented in the form of illustrative, non-limiting examples, and not as exclusive implementations, whether or not they are explicitly called out as examples as described. Many variations, modifications, and additions are possible within the scope of the examples of the disclosure. More generally, examples in accordance with the present disclosure have been described in the context of particular implementations. Functionality may be separated or combined in blocks differently in various examples of the disclosure or described with different terminology, without departing from the spirit and scope of the present disclosure and the following claims. These and other variations, modifications, additions, and improvements may fall within the scope of the disclosure as defined in the claims that follow.

What is claimed is:

1. A data storage device, comprising:
a disk having a disk surface that includes a plurality of tracks in a shingled magnetic recording (SMR) zone;
a head configured to be positioned proximate to the disk surface and including N number of read elements and M number of write elements, wherein N is greater than M; and
one or more processing devices, individually or in combination, configured to:
divide respective data associated with respective write commands into first portions and second portions;
write the first portions to a first track in the SMR zone;
store the second portions in a buffer; and
responsive to an amount of data stored in the buffer reaching or exceeding a limit, write the second portions to one or more additional tracks in the SMR zone.

2. The data storage device of claim 1, wherein:
the first portions comprise one or more respective first data chunks associated with respective ones of the write commands; and
the second portions comprise one or more respective second data chunks associated with the respective ones of the write commands.

3. The data storage device of claim 2, wherein the one or more processing devices, individually or in combination, are further configured to write the one or more respective first data chunks and the one or more respective second data chunks to containers defined in the first track and the one or more additional tracks.

4. The data storage device of claim 3, wherein sequential logical block addresses are mapped to respective ones of the containers in an alternating manner between the first track and the one or more additional tracks.

5. The data storage device of claim 1, wherein the one or more processing devices, individually or in combination, are further configured to delete the second portions from the buffer based on the writing the second portions to the one or more additional tracks in the SMR zone.

6. The data storage device of claim 1, wherein:
the limit equals (N minus M) times a write capacity of a single track in the SMR zone; and
the one or more additional tracks in the SMR zone equals (N minus M) number of tracks.

7. The data storage device of claim 6, wherein:
N equals two;
M equals one; and
the one or more additional tracks in the SMR zone equals one track.

8. The data storage device of claim 1, wherein, in response to a read command for the respective data associated with a respective one of the write commands, the one or more processing devices, individually or in combination, are further configured to pass the read elements simultaneously over the first track and the one or more additional tracks.

9. The data storage device of claim 1, wherein respective ones of the plurality of tracks in the SMR zone overlap one another.

10. The data storage device of claim 1, wherein the one or more processing devices, individually or in combination, are further configured to adjust a write position associated with the one or more additional tracks based on a write position associated with the first track.

11. A method comprising:
dividing, by one or more processing devices individually or in combination, respective data associated with respective write commands into first portions and second portions;
writing, by the one or more processing devices individually or in combination, the first portions to a first track in a shingled magnetic recording (SMR) zone defined on a disk surface of a disk in a disk drive;
storing, by the one or more processing devices individually or in combination, the second portions in a buffer; and
responsive to an amount of data stored in the buffer reaching or exceeding a limit, writing, by the one or more processing devices individually or in combination, the second portions to one or more additional tracks in the SMR zone.

12. The method of claim 11, wherein:
the first portions comprise one or more respective first data chunks associated with respective ones of the write commands; and
the second portions comprise one or more respective second data chunks associated with the respective ones of the write commands.

13. The method of claim 12, wherein the one or more processing devices, individually or in combination, are further configured to write the one or more respective first data chunks and the one or more respective second data chunks to containers defined in the first track and the one or more additional tracks.

14. The method of claim 13, wherein sequential logical block addresses are mapped to respective ones of the containers in an alternating manner between the first track and the one or more additional tracks.

15. The method of claim 11, wherein:
the disk drive comprises M number of write elements in a head corresponding to the disk surface and N number of read elements in the head;
the limit equals (N minus M) times a write capacity of a single track in the SMR zone; and
the one or more additional tracks in the SMR zone equals (N minus M) number of tracks.

16. The method of claim 15, wherein, in response to a read command for the respective data associated with a respective one of the write commands, the one or more processing devices, individually or in combination, are further configured to pass the N number of read elements simultaneously over the first track and the one or more additional tracks.

17. One or more processing devices, individually or in combination, comprising:
means for writing data associated with one or more write commands to paired tracks in a shingled magnetic recording (SMR) zone using M number of write elements in a head; and
means for reading the data using N number of read elements in the head by passing the N number of read elements simultaneously over the paired tracks.

18. The one or more processing devices of claim 17, wherein N is greater than M.

19. The one or more processing devices of claim 17, wherein the one or more write commands comprise a single write command having an amount of data greater than a write capacity of one of the paired tracks.

20. The one or more processing devices of claim 17, wherein the one or more write commands comprise a single write command having an amount of data equal to an even integer multiple of a write capacity of one of the paired tracks.
